(19) United States
(12) Patent Application Publication
(10) Pub. No.: US 2012/0095822 A1
(43) Pub. Date: Apr. 19, 2012

(54) SYSTEM AND METHOD FOR DELIVERING AND SECURELY REDEEMING LOCATION-SPECIFIC PROMOTIONS

(76) Inventor: Steven Chiocchi, Asbury, NJ (US)

(21) Appl. No.: 13/272,667

(22) Filed: Oct. 13, 2011

Related U.S. Application Data
(60) Provisional application No. 61/392,643, filed on Oct. 13, 2010.

(51) Int. Cl. G06Q 30/02

(52) U.S. Cl. 705/14.26

(57) ABSTRACT

A system and method for delivering and securely redeeming localized promotions comprises a consumer interface device such as a smartphone in communication, by a software application and network connection, with a server and database. Each participating vendor is assigned a unique identifier and a device capable of generating and displaying a changing, one-time identification code including the identifier and a timestamp. Once a consumer finds a promotion of interest and visits the offering vendor, the promotion is redeemed at the point of sale via the application activating the consumer's smartphone camera and scanning the code. The application then tags the code with certain metadata, which is transmitted to the server for authentication and archiving. Each promotion redemption thus has a unique code, and analytical consumer data compiled will be highly accurate, unlike strictly GPS-based redemption. The system and method include an element to reward use and encourage promotion sharing.

### CROSS-REFERENCE TO RELATED APPLICATION

This application claims the benefit of U.S. Provisional Patent Application No. 61/392,643, filed 13 Oct. 2010, which is incorporated herein by reference.

### FIELD OF THE INVENTION

The present invention relates to discounts and other promotional programs for businesses and, more particularly, to a system and method for distributing and securely redeeming localized versions of same.

### BACKGROUND

The use of targeted communications by vendors to promote their products and services to consumers can be traced back hundreds, if not thousands, of years, with primitive billboards and posters having been found in ancient ruins.

Despite the effectiveness of modern advertising concepts such as coupon and other customer loyalty programs, there are drawbacks to them. Coupon compilations, for example, are impersonal, not customized, and require consumers to perform much sorting in order to find a “needle in the haystack.” Currently, promotions for small, independent businesses in particular are usually scarce, impersonal, and haphazardly implemented, with coupon redemption rates often leaving something to be desired. Economies of scale come into play, and small businesses frequently lack the monetary and personnel resources to mount an advertising campaign which will effectively penetrate a certain market. To compound matters, the providers of advertising media do not often seek out small business owners.

However, the omnipresence of the Internet and the development of Web 2.0 social media platforms have sparked an explosion of interest in information sharing and collaboration over the World Wide Web, including location-based services. Further, the advanced computing and communication capabilities of the current generation of mobile communication devices, including cellular telephones known as “smartphones,” allows users to run applications with advanced features, including those that utilize Global Positioning System (GPS) capability for location-based services.

Problems arise, though, when only GPS functionality is relied upon to redeem localized promotions. The location tracking available through GPS varies from device to device and, in any event, is only accurate to a certain range and certainly not always able to pinpoint a particular business' point of sale. To compound matters, the location “check-in” option offered by popular social media applications such as foursquare™ and Facebook® may be manually overridden, so that a consumer may represent that he or she is at a certain location even when not physically there (or even anywhere remotely in the vicinity). Any analytical data that is based on the use of such applications will thus be flawed and less valuable to both the participating vendors attempting to track promotion redemptions and any parties interested in selling or buying such data.

### SUMMARY

The present invention may comprise one or more of the features recited in the attached claims and/or one or more of the following features and combinations thereof. The system and method disclosed herein allows participating vendors, businesses both large and small, to strategically target and maximize exposure in one or more geographic areas through localized and categorized promotions of interest which are presented to consumers on their smartphones or other mobile communication devices. Because the system and method do not rely on GPS tracking for the act of promotion redemption, but rather a face-to-face transaction involving specialized hardware, the redemption analytical data generated is highly accurate.

An illustrative system and method for delivering and redeeming location-specific promotions includes a software application capable of execution on a smartphone, tablet or other portable computer, or other programmable processor having scan or camera functionality and a server, likely located remotely. The server has access to a back-end database for storing information relating to participating vendors and their promotions as well as consumers, their demographics, and the particular promotions they redeem. The application and server are in communication via a wireless or other electronic network connection.

Consumers may interface with the system using a smartphone or other mobile device capable of wireless communication; such an interface device can include a wireless receiver and a display for receiving and selectively displaying navigational information and promotional offers and having input capability such as a touchscreen. Consumers may also access the participating vendors' coupons and other promotional offers through a website, comprising a collection of webpages hosted on at least one World Wide Web server, accessible via a network such as the Internet or a private local area network.

The smartphone software application (colloquially referred to as an “app”) is downloaded by a consumer and organizes participating vendors' promotions within a certain radius of the consumer's then-current GPS location, making the promotions available to the consumer directly on his or her mobile device. In particular, the application will be programmed to allow the consumer to sort through available promotions by entered keywords, by location, and/or by category, such as beauty salons, restaurants, movie theaters, nightlife and other entertainment, sporting events, clothing retailers, book and record stores, general shopping, and special events.

If a category is selected by the consumer, a localized listing of the relevant participating advertisers is displayed on the consumer's device. Once the consumer chooses a vendor or event in which he or she is interested, the application will display at least one discount, rebate, or other promotion related to the vendor or event. This promotion will have been previously arranged or at least approved by the relevant participating vendor, and it may be redeemed via the consumer visiting the vendor's place of business and the application activating the camera function on the consumer's smartphone. The smartphone camera is used to scan a unique, periodically-changing barcode or other vendor-identifying information displayed on a vendor's tablet computer or other device. The application running on the smartphone then “tags” or links the transaction with back-end metadata, such as consumer name, age, gender, and the offer redeemed, and transmits the data to the server, which will authenticate the redemption through its access to all vendor and promotion information stored in the database and archive the redemption data in the database. Each vendor will have a unique identifier and each customer will receive a distinctive redemption code, as a timestamp is an element incorporated in the unique identification code.

Alternatively, if scanning is not possible due to low or high lighting, or some other factor, the promotion may be redeemed by showing the display on a mobile device to the vendor or presentation of a hard-copy coupon, with an alphanumeric version of the unique code being manually entered into the application executing on the consumer's smartphone.

Because the consumer's physical presence at the point of sale is required for promotion redemption and a unique code is utilized for each transaction, the possibility of fraudulent transactions and flawed analytical data, as is seen with strictly GSP-based redemption, is virtually eliminated. Demographic and other information obtained from use of the system and method will be highly reliable. In addition to maintaining data regarding participating vendors and their promotions, the back-end database, which is stored on the server or at least in communication with the server, provides a centralized repository of this valuable demographic information concerning the consumers and their promotion-redemption choices.

Additional application features include a referral program whereby more attractive promotions are received by a user who frequently utilizes the system and/or recommends the application or particular promotions to other consumers. A rating system built within the application allows consumers to leave feedback about specific vendors or promotions which may, in turn, be viewed and utilized by other consumers using the system.

An illustrative method may include the step of identifying and contracting with businesses which are willing to offer promotional deals through the system disclosed herein. The participating vendors will approve each of their respective promotions, as well as any related advertising, to be offered by the application. Generated and maintained is a back-end database of participating vendors, which are each associated with one or more geographic areas in which they do business. It is envisioned that, in one embodiment, the entire method of identifying participating advertisers, building and populating a database to hold vendor and promotion-related information, and generating and distributing the coupons or other promotional materials can be performed by one or more specially-programmed computers or other processors.

Given the tremendous popularity of mobile telephones and the software applications which can be executed on them, the present system and method will stimulate business by providing increased in-person customer traffic and will benefit the consumer through the promotions offered and the better deals resulting from the increased competition between businesses.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a schematic of the elements employed in an illustrative system for delivering localized promotions to consumers and securely redeeming same;

FIG. 2 illustrates a home screen of the application used by the consumers in FIG. 1;

FIG. 3 illustrates a grouped vendor listing screen of the application used by the consumers in FIG. 1;

FIG. 4 illustrates a keyword search screen of the application used by the consumers in FIG. 1;

FIG. 5 illustrates a location-based search screen of the application used by the consumers in FIG. 1;

FIG. 6 illustrates a vendor-specific promotion listing screen of the application used by the consumers in FIG. 1;

FIG. 7 illustrates a promotion redemption and sharing screen of the application used by the consumers in FIG. 1;

FIG. 8 illustrates a promotion code-scanning screen of the application used by the consumers in FIG. 1;

FIG. 9 illustrates a promotion-redeemed screen of the application used by the consumers in FIG. 1; and

FIG. 10 is a flowchart of the steps utilized in an illustrative method for delivering localized promotions to consumers and securely redeeming same.

### DESCRIPTION OF THE ILLUSTRATIVE EMBODIMENTS

For the purposes of promoting and understanding the principals of the invention, reference will now be made to one or more illustrative embodiments illustrated in the drawings and specific language will be used to describe the same.

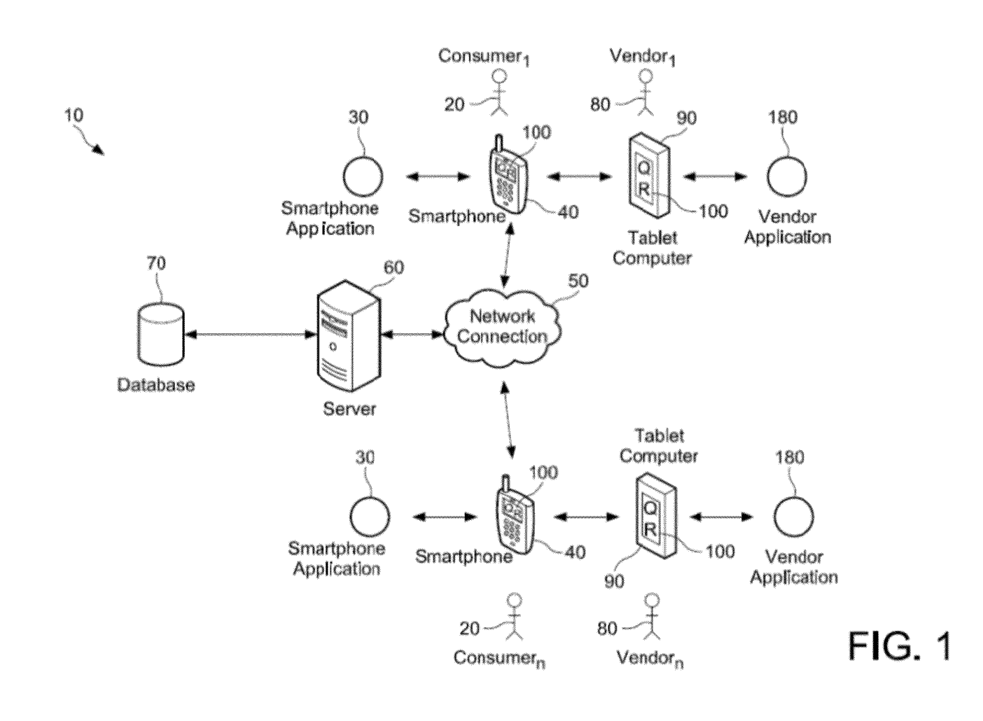

Referring to FIG. 1, a schematic of the elements used in an illustrative system 10 and method for delivering localized promotions to a consumer 20 and redeeming same is shown. Executing a software application 30, a consumer's smartphone or other mobile communication device 40 will utilize an Internet or another type of network connection 50 to communicate with a server 60. The server 60, possibly remotely located, is in communication with a back-end database 70 which maintains various types of information, including that regarding the content, category, and physical location for the redemption of discounts, rebates, free product and/or service offers, and various other promotions offered by participating vendors 80. The database 70 may be hosted on the server 60 or stored on another computer in communication with the server 60.

The consumer 20 will interface with and navigate the options offered by the application 30, select a promotion of interest, and visit the place of business of the respective participating vendor 80. Each participating vendor 80 is equipped with at least one computer 90 or other specially-programmed processor capable of displaying a unique, periodically-updated promotion identification code 100 for imaging or another form of entry into the consumer's smartphone 40. In one illustrative embodiment, the vendor's computer 90 is a tablet computer, moved around the vendor's place of business for ease of conducting transactions with the consumer 20 at the point of sale, which is an inclusive term for the seats, tables, bars, or any other areas at the vendors' respective business locations. The smartphone application 30 is capable of transmitting the captured secure identification code 100 to the server 60 for processing, archiving, and, optionally, verification.

As an initial matter, in this illustrative embodiment, a consumer 20 downloads the application 30, through one or more Web server computers or other specially-programmed processors reached through an established wireless or wired connection, onto his or her smartphone 40 or other mobile communication device. The consumer 20 may be required to create an account with a personally-identifying user name and password, for security and demographic-tracking purposes.

Once initialized and otherwise ready for consumer input, a home or root menu, offering options for searching the system 10 for localized promotions, is displayed on the consumer's smartphone 40. The consumer 20 navigates the application 30 through the techniques known to those in the computing device art, including the touchscreen capability of certain smartphones and tablet computers as well as keyboard or mouse input.

The root menu allows the consumer 20 to select from a variety of options for navigating the application 30 and obtaining the desired type of discount, rebate, or other promotional offer. Such choices illustratively include an option to run a keyword-based, text search for the name of a particular vendor or particular types of goods or services, a GPS-based vendor search option, an option to retrieve previously-saved promotional offers, an option to be directed to a listing of participating vendors whom the consumer has “bookmarked” as favorites, an option for sharing news about the application and referring potential consumers, and a profile option which directs the consumer to information pertaining to his or her account.

As with all of the application 30 screens presented to the consumer 20, in one embodiment, a title bar 110 displays the name of the page being viewed, which assists the consumer 20 in maneuvering through the various options. Space on the display may be reserved for advertising. Participating vendors 80, or potentially vendors not otherwise participating in the location-based promotion program, may contract, possibly paying a premium, for their placement of advertising in this space.

As indicated, the application 30 includes, in an illustrative embodiment, a location-based option allowing the consumer to search for discounts, rebates, free product and/or service offers, and various other promotional offers based on, and relevant to, the consumer's current Global Positioning System (GPS) location, as provided by a GPS navigation device in the consumer's mobile device 40 or other processor. The consumer 20 may specify that he or she is open to receiving coupons and promotional information from vendors 80 within a certain radius of his or her GPS location.

Needed geographic information to be provided by the GPS navigation system, whether present in a mobile device or other processor, includes the current latitude and longitude of the consumer 20. In one illustrative embodiment, this GPS-based search option employs a Web mapping technology such as Google Maps to provide the needed geographic information. If a GPS device or a GPS signal is not available, it is envisioned that the system could rely on a GPS receiver external to the consumer's smartphone 40 or other positioning systems such as cellular telephone tower signals, wireless Internet signals, Bluetooth sensors, or local positioning systems.

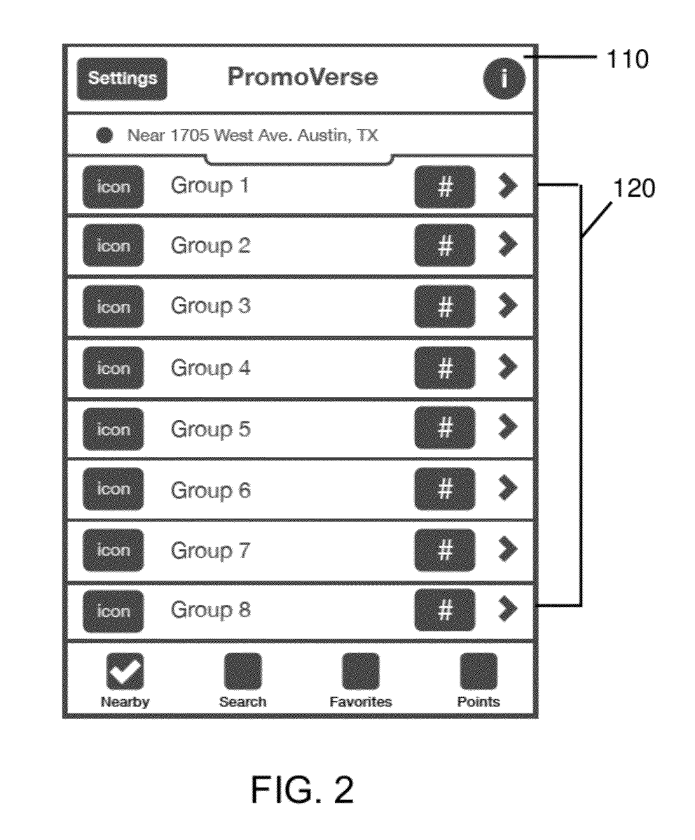

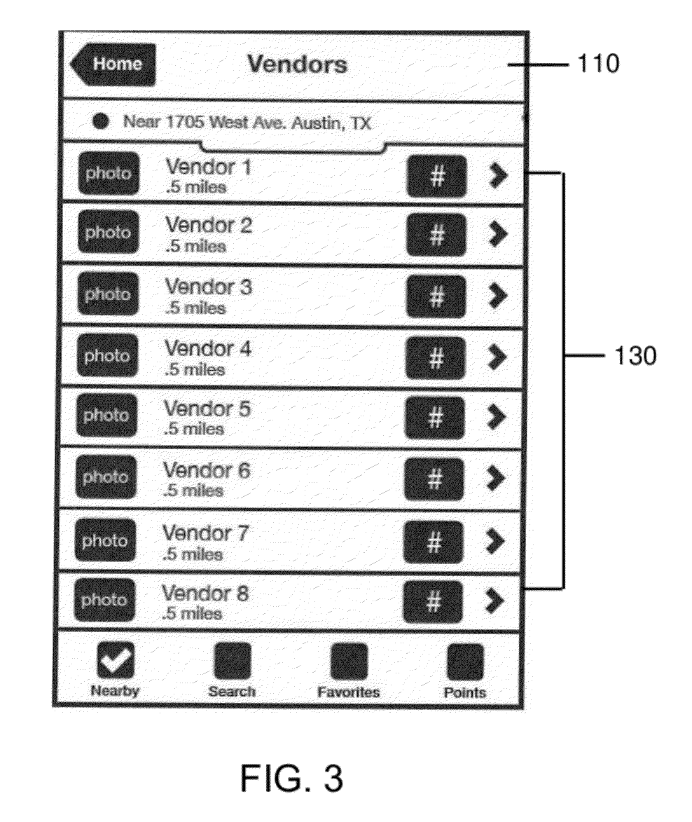

FIG. 2 depicts an illustrative application 30 home screen shot for initiating a search for nearby promotions of interest. Promotions of participating vendors 80 appear in groups 120 from which the consumer 20 may select one by providing touchscreen or other input. Once a promotion group 120 is selected by the consumer 20, he or she is presented with a list 130 of vendors within that group 120. As seen in FIG. 3, the list 130 may specify, and by organized by, distance from the then-current GPS location of the consumer 20.

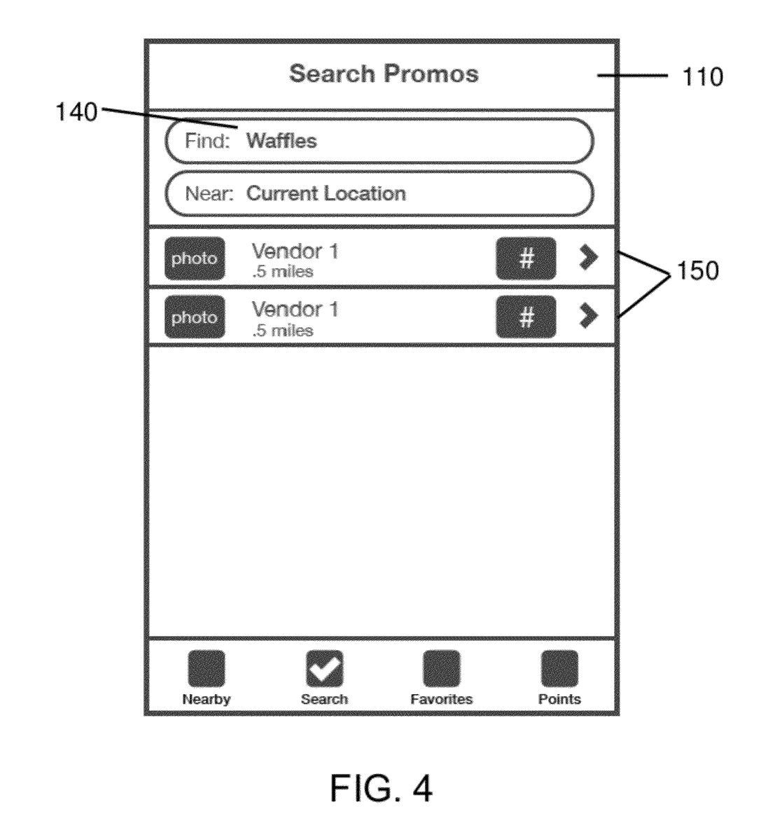

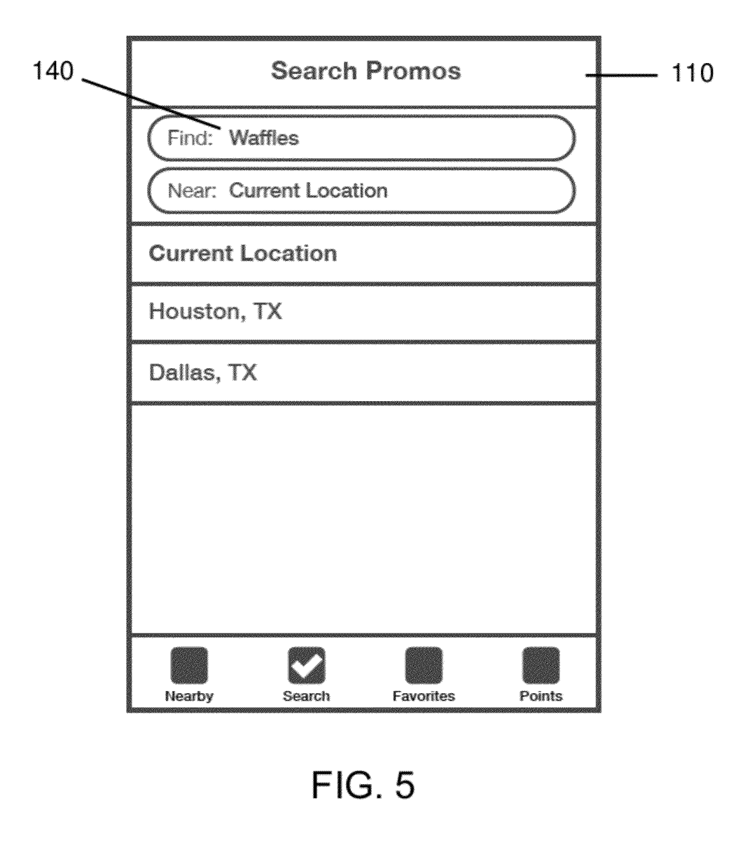

With reference to FIG. 4, in addition to offering GPS-location based searching for promotions, the application 30 may offer the consumer 20 the option of searching for promotions of interest by entering one or more keywords 140. The results 150 of such searches may be categorized with respect to the consumer's GPS location. The keyword search results may be limited by consumer 20 selection to a specific area, such as a city, as seen in FIG. 5.

Alternatively, a specific geographic subdivision, such as a county, may provide the basis for searching for promotions of interest. In this embodiment, the back-end database 70 will store a county-level map of one or more geographic areas, such as the United States of America. The consumer 20 may navigate this map to reach a particular county or other defined area, where he or she resides, works, or will be visiting. Then, once a promotion genre is selected by the consumer 20, a listing of participating vendors 80 doing business within the selected county and within the selected genre appears on the display screen. From there, the consumer 20, in one embodiment, may review the respective vendors' coupons or other promotions as well as ratings assigned to the vendors 80 by other consumers 20 using the system 10.

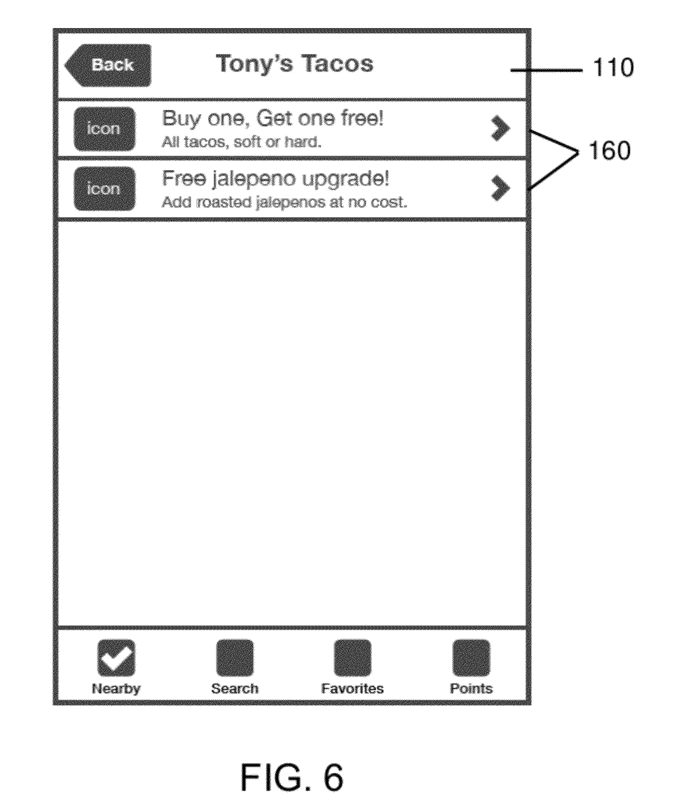

Shown in FIG. 6, whether reached based on GPS location or by a keyword search, the consumer 20 eventually encounters a participating vendor 80 and the one or more promotions 160 which that vendor 80 is offering through the system 10. As noted, the application's rating element allows a consumer 20 to leave feedback, via their smartphones 40 or other input devices, about the participating vendors 80 and their promotions 160. Other consumers 20, then, may review the feedback and determine whether they desire to do business with a given vendor 80, based on this input. The feedback is shown, at least as one or more icons or alphanumeric characters for quick reference, on the respective vendor promotion 160 listings, with an option to navigate to a more complete recitation of all the feedback relating to a given participating vendor 80. Additionally, the application 30 can provide, for quick reference, a selection of the consumer's browsing and selection history or other relevant data and communications. This would include, for example, data relating to a preferred category of vendors or certain geographic area.

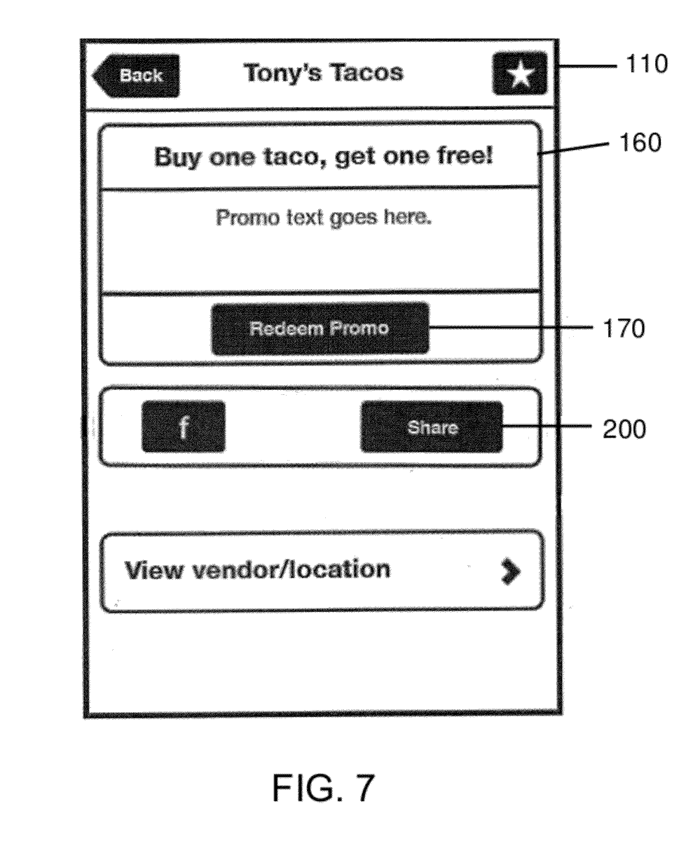

After the consumer 20 provides the touchscreen or other input necessary to select a particular participating vendor 20 and desired promotion 160, as seen in FIG. 7, the consumer 20 is presented with the option to redeem the promotion 160 or share it. Selecting the redeem option 170 will activate a camera or scan mode on the consumer's smartphone 40, and the mobile device will begin “looking” for an image capable of scanning At this point at least, the consumer 20 must be physically present at the point of sale.

Executing a separate, token-generating software application 180 of its own, the chosen vendor's tablet or other computer 90 generates and displays a unique identification code 100, a “key” for authenticating the promotion 160 redemption transactions which may be a barcode or other optical, machine-readable representation of data or an alphanumeric sequence, for the proposed redemption transaction with the consumer 20.

In one illustrative embodiment, the vendor's tablet 90 or other computer runs on Google, Inc.'s popular Android operating system for mobile devices, while the token application 180 is a java/j2me applet utilizing a seed. The seed consists of two elements pre-formed by operation of the token-generating application 180: a first element which is pre-loaded onto the vendor's tablet 90 or other computer prior to the computer 90 being presented to the vendor 80 and may correspond to the asset number of the device 90, and a second element which is entered into the tablet 90 or other computer after possession of it has passed to the vendor 80, through means such as a third-party representative or supplying the needed information by an automated telephone system. The seed is a shared secret known only to the vendor's tablet 90 or other computer and the database 70, and it, in connection with the current time, is used to generate the unique identification code 100. Each vendor 80 will thus have a unique identifier and no need for an Internet connection in order to generate a unique identification code 100.

The unique identification code 100, then, serves as a one-time code for redeeming, at the very point of sale, a promotion 160 selected by a consumer 20. In one illustrative embodiment of the present system and method, the unique identification code 100 is either an optical representation for scanning by the consumer's smartphone 40 or a PIN-type alphanumeric sequence which is manually entered by typing into the application 30 running on the smartphone 40. For security purposes, the code 100 generator may be configured with a timing element to automatically change the display of the unique identification code 100 on a vendor's tablet 90 or other computer 90 within a defined short period of time, such as every sixty seconds. Alternatively, the generation of the unique identification code 100 may be done upon a vendor 80 entering a demand request on the tablet 90 or other computer.

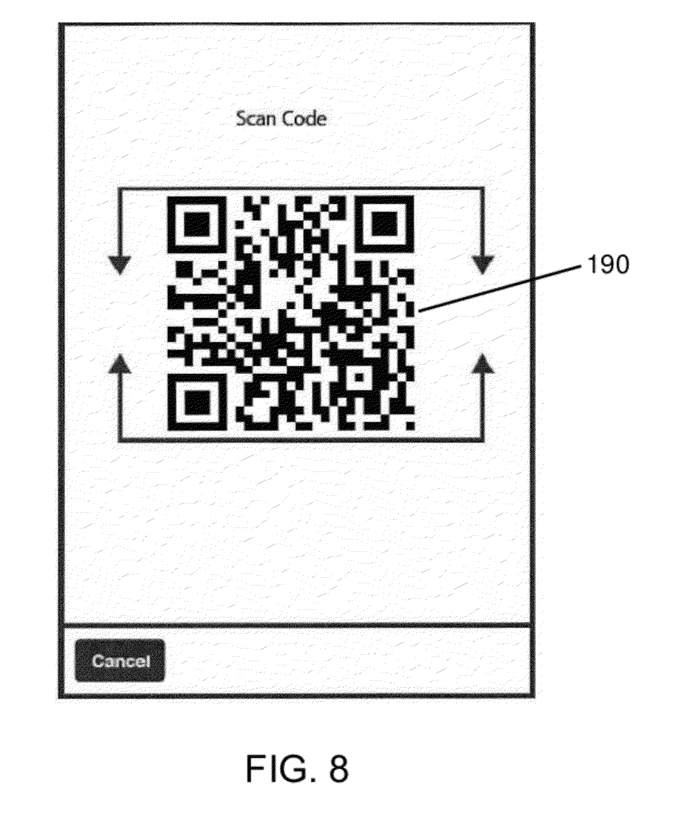

As seen in FIG. 8, one of the forms for the unique identification code 100 is the increasingly-familiar, optical Quick Response (QR) code 190, a public domain technology comprising a type of two-dimensional or “matrix” barcode for representing information. Typically, a QR code 190 is represented as black modules arranged in a square pattern on a white background. In QR code 190 format, the unique identification code 100 is generated using the current date and time and the seed, and it will contain at least the following information in an illustrative embodiment: a timestamp, vendor identification, device identification, and redemption code. When the unique identification code 100 is presented as an alphanumeric sequence, it may be a nine-digit code presented for redemption in ping/passphase format, containing at least the following properties: a timestamp, vendor identification, device identification, and redemption code. The application 180 running on the vendor's tablet computer 90 may be configured to offer the alphanumeric sequence through an option on the screen displaying the QR code 190. If in an environment, such as a nightclub with a low level of ambient lighting or outdoors in bright sunlight, the selected promotion 160 may be easily redeemed by manual entry of this alphanumeric sequence version of the identification code 100 displayed on the vendor's tablet computer 90. It is further envisioned that any number of means for uploading data to a computer may used for entering the unique identification code 100 into the consumer's smartphone or other mobile device 40, including, but not limited to, the use of flash drives or a wired connection between the vendor's tablet computer 90 and the smartphone 40.

Once scanned, typed, or otherwise entered into the consumer's smartphone 40 or other mobile communication device, the consumer application 30 automatically tags or links the unique identification code 100 with metadata regarding the particular consumer 20 and transmits the promotion 160 redemption request to the server 60 via the network connection 50. Such metadata may include, but is not limited to, vendor identification, location, promotion identification, and/or a demographic profile of the consumer 20. In one embodiment, consumers 20 create accounts in order to use the application 30 and provide consent to have their accounts linked with social media accounts such as those established for the FACEBOOK® and TWITTER® services. Demographic information, such as gender and age, obtained from those social media services may be among that tagged to the unique identification code 100 and transmitted to the server 60.

After the unique identification code 100 has been entered into the consumer's smartphone or other mobile device 40, in one illustrative embodiment, the smartphone application 30 decodes the tagged code 100 into data in the Uniform Resource Identifier (URI) format and prepares a redemption request for transmission to the server as soon as a network connection 50 is established. The URI format is a string of characters used to identify a name or a resource and enable interaction with resources over a network. All attempts by a consumer 20 to redeem a promotion 160 occur through a network 50 session, authenticated by means known in the computer networking art such as a cached unique identifier (UID) and session identification (ID), between the consumer's mobile communication device 40 and the server 60. The server 60 preferably has the ability to normalize redemption requests coming from a variety of mobile consumer devices and formats.

Among the software elements executing on the server 60 is one which authenticates and otherwise manages unique identification codes 100 through at least three subcomponents: a generator for creating the codes 100, similar to the token-generating application 180 on the vendor's tablet computer 90; a store that retains the codes 100 as generated by the server 60 and preferably uses fast-search techniques such as hash tables and split databases; and a finder that utilizes the store in order to validate promotion 160 redemption attempts by executing a look-up operation based on the timestamps, seeds, and metadata tagged to the various redemption attempts. The server 60, by reference to the database 70, will know both elements of each seed used by the tablet application 90 for every participating vendor 80 and thus be able to locally generate the unique identification codes 100 based on the current date and time and, through comparison, validate or reject promotion 160 redemption requests received from consumers' smartphones 40. A bouncer component on the server 60 may be used to queue and cache the redemption attempts and pass them in an orderly fashion to the finder. In one embodiment, an archiver element compiles and stores vendor, promotion, and consumer information for each normalized promotion 160 redemption request for historical and analytical purposes.

Because the present system and method require the presence of the consumer 20 at the point of sale and verification of the promotion 160 redemption by a one-time code 100, and the system and method may be configured to accept a given code 100 only once, the possibility for fraudulent redemptions is negligible. Accordingly, analytical data compiled from the promotion redemptions will be highly accurate and valuable to vendors 80 and marketing firms, among others.

In one illustrative embodiment, the system 10 includes an element for a referral program that is designed to reward the loyalty of consumers 20 and promote the sharing of promotions 160 through online social networking platforms and sites. Consumers 20 using the system 10 will each have an assigned loyalty point ranking, which may be reflected on a mobile device 40 or monitor screen numerically, graphically, or in any other fashion capable of indicating quantity. The consumers' 20 loyalty ranking may be updated at the time of promotion 160 redemption request authentication or at a subsequent time.

Essentially, the more people with whom a consumer 20 using the system 10 takes advantage of, or recommends, available promotions 160, the higher the consumer's 20 ranking will be. In one embodiment, a plurality of referral levels or tiers is defined and, the higher a given consumer's 20 ranking, the more enticing the promotions 160 he or she receives through the application 30 will be. In other words, certain promotions 160 will only be available for consumers 20 at a certain referral level. As a consumer 20 using the system 10 shares the promotions 160 through social networking services, such as the popular FACEBOOK® and TWITTER® services, his or her ranking on the application 30 will be scored higher or better. In one embodiment, referrals to others may be with respect to the system 10 and application 30 in general and/or particular participating vendors 80 and their promotions 160.

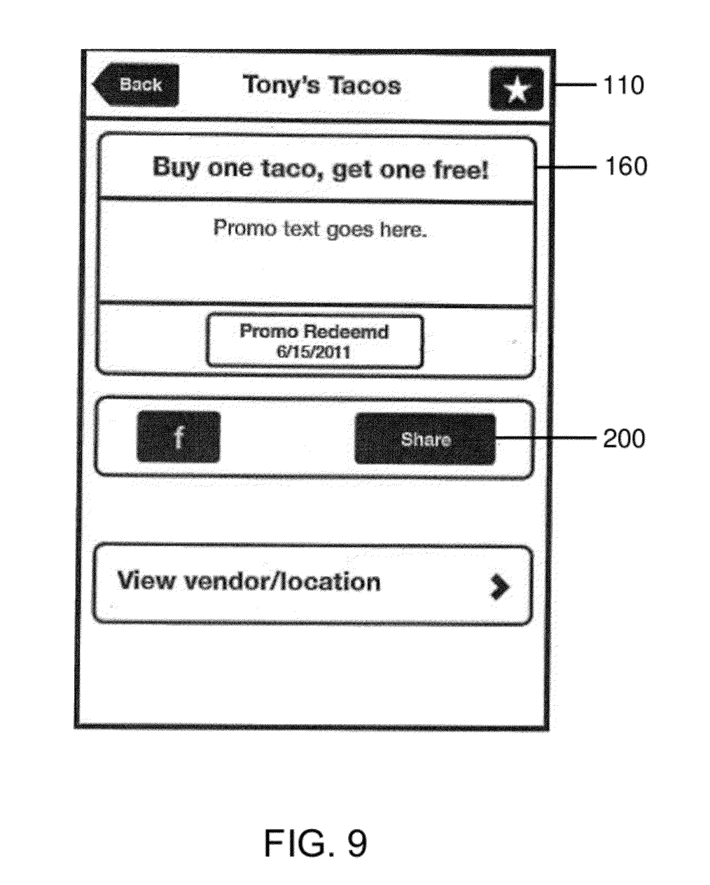

Referrals may be made by selecting a share screen icon 200 appearing on a mobile device's display, such as the one seen in FIGS. 7 and 9, which will open a separate social networking application on the device 40, open a separate application for electronic mail, or open a separate application for a text messaging or short message service. The referral is then transmitted through the social networking service, electronic mail, or text message. With respect to transmittal through a social networking service, it may take place through a posting on the consumer's profile page open to viewing by friends. For purposes of tracking referrals and ensuring that a referring consumer 20 gets the credit to which he or she is entitled, the application assigns each consumer 20 a unique member referral code. This code is automatically embedded in every hyperlink or other referral transmitted by a consumer 20 through the system 10.

In an illustrative embodiment, the consumer's smartphone 40 for interfacing with the application 30 includes any handheld mobile device providing a display; input capability, including, but not limited to, that for touch-scrolling; and communication with the network 50. Exemplary smartphone 40 or handheld mobile devices include those available from Apple, Inc., of Cupertino, Calif.; Palm, Inc., of Sunnyvale, Calif.; and Research In Motion Limited, Inc., of Waterloo, ON, Canada. It should be noted that the role served by the smartphone 40 is very inclusive and may be filled by a wide variety of computing machines or other programmable processors such as notebook, laptop, or tablet computers; handheld portable devices; mobile telephones; or other client processors capable of communication over the Internet, a wide-area electronic network (WAN), a local-area electronic network (LAN), or another communication system.

For the network connection 50, the handheld mobile device 40 can access features of the system 10 via the Internet or any other communication link known in the art, including, for example, a Bluetooth connection, a LAN such as IEEE 802.11, and/or a WAN such as a cellular communications network. Moreover, data transmissions may be encrypted by methods known in the computer science art, such as the use of Hypertext Transfer Protocol Secure (HTTPS) networking protocol, a combination of the Hypertext Transfer Protocol (HTTP) and the Secure Sockets Layer (SSL)/Transport Layer Security (TLS) protocols, to provide encrypted communication and secure identification of the server 60.

More particularly, the specific software application 30, or “app,” is ported such that it is executable in a variety of operating systems for mobile telephones and quick messaging devices, including Apple Inc.'s iOS, Android by Google, Microsoft Windows Mobile, Symbian OS, and BlackBerry OS. It is further envisioned that the application 30 will be executable in a wide variety of operating systems beyond those specifically for mobile devices, such as Microsoft's Windows XP and Windows 7, Apple's Mac OS X, and Linux.

It is envisioned that, through a Web site, the consumer 20 may access the same system 10 features available through the mobile device application 30. As implemented through a Web site in one illustrative embodiment, the system 10 will be accessible with Web browser software, preferably having a graphical user interface, in communication with the Internet or another wide-area or local electronic network 50 capable of communicating with a Web page or collection of individual Web pages forming a Web site, by virtue of a signal running through at least one server computer or processor. Such a Web page or Web site is created and populated with content by methods known to those in the computer science art, including, but not limited to, the formatting instructions of Hypertext Markup Language (HTML) or Extensible Hypertext Markup Language (XHTML).

As indicated, the application 30 running on the consumer's smartphone 40 is in communication through the Internet or other network connection 50 with a back-end database 70 that stores and accesses information relating to, among other things, the participating vendors 80, their particular promotions 160, the seeds for generating the unique identification codes 100, and consumers 20 and their promotion 160 redemptions. Those in the art will see the benefits of using a structured database as a repository, wherein records and files are organized in a uniform format. A structured database processes data objects as ordered “relational” records with attribute pairing. For example, in contrast to a newspaper's unstructured database of individual articles, an online book retailer may use a structured database capable of returning, in response to a query, the title, format, and price of a particular work.

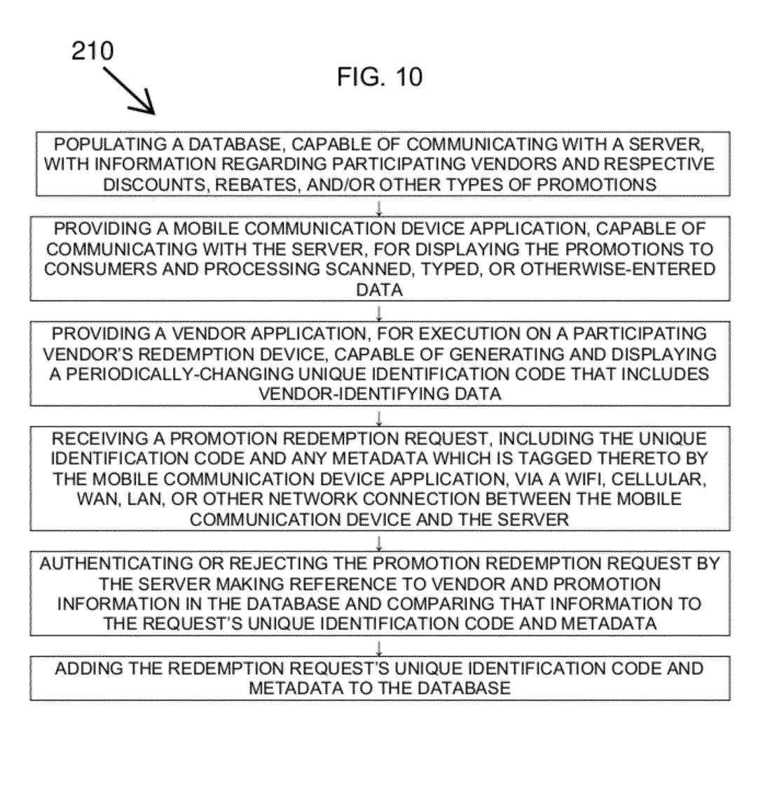

When implemented as a method 210, as seen in FIG. 10, an illustrative embodiment utilizes the various system 10 elements. It may include the preliminary step of identifying businesses which are willing to purchase advertising and/or offer promotional deals and participate as a vendor 80 in the system 10 disclosed herein and executing contracts or otherwise reaching agreements with those businesses. The participating vendors 80 will approve each of their respective promotions 160, as well as any related advertising, to be offered by the application 30 utilized by consumers 20. The specific terms of these contracts or agreements will undoubtedly vary and change as time passes and the participating vendors 80 wish to modify their level and/or form of participation. Subsequently, the database 70 is built and populated with information regarding, among other the vendors 80, their promotions 160, and, as they occur, redemptions of the promotions 160. It should be understood, however, that all of the illustrated steps are merely exemplary. Other steps may be added and some may be omitted. Furthermore, variations in the step sequence are envisioned, and the order of the steps may certainly be changed for different embodiments of the system 10.

While the present invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. A system for the secure redemption of promotions comprising:
a consumer mobile communication device application capable of displaying vendor promotions and processing data entered by optical scanning, typing, or another method of entry;
a vendor application capable of generating a unique identification code, including vendor-identifying data, that is periodically updated by a timing element at least every sixty seconds or upon vendor demand;
a vendor redemption device capable of executing the vendor application and displaying the unique identification code;
a database of information identifying one or more participating vendors, their respective promotions and redemptions thereof, and consumers registered to utilize the mobile communication device application; and
at least one server capable of communicating with the database and the consumer mobile communication device application,
whereby, upon a promotion redemption request proposed by a consumer, the unique identification code is scanned, typed, or otherwise entered, at a point of sale, into the mobile communication device executing the consumer mobile communication device application, and the server receives information relating to the redemption request, including the unique identification code and promotion-identifying information, as submitted by the consumer mobile communication device application and authenticates or rejects the request by reference to the vendor, promotion, and consumer-identifying information in the database.

2. The system of claim 1 wherein the consumer mobile communication device is a smartphone.

3. The system of claim 1 wherein the vendor redemption device is a tablet computer or other portable computing device.

4. The system of claim 1 wherein the server communicates with the consumer mobile communication device application over a WiFi, cellular, WAN, LAN, or other electronic network.

5. The system of claim 4 wherein the network utilizes an authenticated connection between the server and the consumer mobile communication device.

6. The system of claim 1 wherein the consumer mobile communication device application displays one or more promotions based on a user's GPS location.

7. The system of claim 1 wherein the consumer mobile communication device application displays one or more promotions based on one or more keywords entered by a user.

8. The system of claim 1 wherein the server is located remotely from the consumer mobile communication device.

9. The system of claim 1 wherein the unique identification code is a Quick Response (QR) code.

10. The system of claim 1 wherein the unique identification code is a sequence of alphanumeric characters.

11. The system of claim 1 wherein the unique identification code is generated using a seed, including an element correlating to a vendor redemption device asset number, and combined with date and/or time information.

12. The system of claim 1 wherein the consumer mobile communication device application, for each promotion redemption request, tags the unique identification code with metadata.

13. The system of claim 12 wherein the metadata includes location and promotion identifying information.

14. The system of claim 1 wherein the consumer mobile communication device application includes a referral element utilized by a consumer in order to receive preferred promotions.

15. A method for the secure redemption of promotions comprising the steps of:
providing a database capable of communicating with a server and populated with information regarding one or more vendors and their respective promotions;
providing a mobile communication device application, capable of communicating with the server, for displaying the promotions to consumers and processing data that is scanned, typed, or otherwise entered into a mobile communication device;
providing or assigning the vendors one or more redemption devices capable of generating and displaying a unique identification code, including vendor-identifying data, that is periodically updated at least every sixty seconds or upon vendor demand;
receiving a promotion redemption request, including the unique identification code and any metadata which is tagged thereto by the mobile communication device application, via a WiFi, cellular, WAN, LAN, or other electronic network connection between the mobile communication device and the server;
authenticating or rejecting the promotion redemption request by the server making reference to vendor and promotion information in the database and comparing that information to the request's unique identification code and metadata; and
adding the information comprising the unique identification code and metadata to the database.

16. The method of claim 15 wherein the unique identification code is a Quick Response (QR) code.

17. The method of claim 15 wherein the unique identification code is a sequence of alphanumeric characters.

18. A system for the secure redemption of promotions comprising:
a consumer mobile communication device application capable of communicating with a server and displaying vendor promotions and processing data entered by optical scanning, typing, or another method of entry;
a vendor application capable of executing on a vendor redemption device and generating a unique identification code, including vendor-identifying data, that is periodically updated by a timing element at least every sixty seconds or upon vendor demand and displayed on the vendor redemption device; and
a database, capable of communicating with the server, of information identifying one or more participating vendors, their respective promotions and redemptions thereof, and consumers registered to utilize the mobile communication device application,
whereby, upon a promotion redemption request proposed by a consumer, the unique identification code is scanned, typed, or otherwise entered, at a point of sale, into the mobile communication device executing the consumer mobile communication device application, and the server receives information relating to the redemption request, including the unique identification code and promotion-identifying information, as submitted by the consumer mobile communication device application and authenticates or rejects the request by reference to the vendor, promotion, and consumer-identifying information in the database.
